(19) United States
(12) Patent Application Publication
(10) Pub. No.: US 2024/0298664 A1
(43) Pub. Date: Sep. 12, 2024

(54) METHOD FOR OPERATING A FULLY AUTOMATIC COFFEE MACHINE AND FULLY AUTOMATIC COFFEE MACHINE

(71) Applicant: Melitta Professional Coffee Solutions GmbH & Co. KG, Minden (DE)

(72) Inventors: Bernd BUCHHOLZ, Rahden (DE); Thomas DIESTER, Bueckeburg (DE); Patrick WILKE, Bueckeburg (DE)

(73) Assignee: Melitta Professional Coffee Solutions GmbH & Co. KG, Minden (DE)

(21) Appl. No.: 18/273,096

(22) PCT Filed: Jan. 18, 2022
(86) PCT No.: PCT/EP2022/051004

§ 371 Date: Jul. 19, 2023

(30) Foreign Application Priority Data
Jan. 20, 2021 (DE) 10 2021 101 151.5

(51) Int. Cl. A23F 5/26; A47J 31/36; A47J 31/42; A47J 31/52; A47J 31/54

(52) U.S. Cl. CPC A23F 5/262; A47J 31/3671; A47J 31/42; A47J 31/5255; A47J 31/54

(57) ABSTRACT

A method for making a coffee beverage with a filter-coffee taste uses a coffee machine that has a brewing unit with a brewing chamber and a plunger which is movable in the brewing chamber and is intended for setting a brewing-chamber volume. The brewing chamber is filled with ground coffee and water is fed into the brewing chamber for the purpose of extraction in the course of a brewing process. During at least one brewing phase, the plunger is arranged so that the volume of the brewing chamber is greater than the volume of the ground coffee in a loosely filled state in the brewing chamber after filling with coffee. The brewing process comprises several brewing phases, in which water with different flow rates is made to pass through the ground coffee. The change between the brewing phases is performed by measuring instruments detecting and/or determining a physical variable.

The present invention relates to a method for operating a fully automatic coffee machine according to the preamble of claim 1, and to a fully automatic coffee machine according to the invention.

The person skilled in the art knows fully automatic coffee machines, which produce various coffee variants according to the espresso method, i.e. under pressure.

Furthermore, there have long been conventional machines for the production of filter coffee. Due to the comparatively slow and low-pressure brewing process, a coffee with a very balanced taste and aroma is achieved.

In conventional espresso production, the aroma is released quickly. The brewing process, which is usually less than 30 seconds for a cup of coffee in a fully automatic coffee machine, releases more essential oils and aromas due to the pressure of about 7.5-9 bar, but less caffeine, tannins and bitter substances due to the short brewing time. There are enthusiasts for both types of coffee.

DE 42 40 175 C1 discloses a brewing unit with an automatically operating coffee machine. The choice of coffee production is made by the brewing position of the brewing plunger. Café Crème is made by coffee pressing, whereas filter coffee is made without coffee pressing. A similar setting between cream coffee and filter coffee is made in DE 33 16 157 A1.

EP 0 909 542 A1 discloses a coffee machine for selectively brewing a filter coffee and an espresso coffee.

U.S. Pat. No. 6,513,419 B2 and WO 2007/060 694 A1 each disclose a coffee machine for preparing various types of coffee, including filter coffee.

These aforementioned documents do not disclose any division of the brewing process of the filter coffee into several brewing phases. A balanced extraction of the respective flavors can therefore not be achieved.

DE 20 2016 008 296 U1 is cited as further prior art, but this does not relate to the production of filter coffee.

DE 10 2018 116 306 A1 discloses various characteristics of a filter coffee as distinguished from other types of coffee, such as espresso. A preparation of filter coffee with several brewing phases is not disclosed, rather in this case admixing of coffee powder takes place parallel to the brewing process, wherein the amount of water/volume flow can be constant or preferably variable and preferably also monitored once or continuously.

The invention is therefore based on the object of operating a fully automatic coffee machine in such a way that a coffee with a taste comparable to filter coffee is provided.

The invention solves the problem by an operating method having the features of claim 1 and by providing a fully automatic coffee machine according to the invention.

A method according to the invention for producing a coffee beverage with a filter coffee flavor is carried out by a fully automatic coffee machine.

The fully automatic coffee machine comprises at least one brewing unit having a brewing chamber and a plunger which is movable, in particular linearly displaceable, in the brewing chamber for adjusting a volume of this brewing chamber of the brewing unit. Such fully automatic coffee machines are known per se, but are not usually used for making filter coffee, but for making espresso or espresso-based beverages.

The plunger is moved mechanically by an actuator, e.g. motorized or hydraulic, which adjusts the brewing chamber volume.

The method according to the invention is characterized by the following steps of:
a. filling the brewing chamber with ground coffee; and
b. feeding water into the brewing chamber for the purpose of extraction in the course of a brewing process.

In this case, at least the plunger is arranged during at least one brewing phase of the brewing process in a position in which the brewing chamber volume is greater than the volume of the ground coffee in a loosely filled state in the brewing chamber after the filling according to step a has taken place. This loosely filled state refers to the poured volume that occurs when an amount of ground coffee corresponding to the amount of ground coffee in the brewing chamber from step a is present in an uncompacted state.

In the first position of the plunger, the volume of the brewing chamber is expanded in such a way that a suspension of ground coffee and water can be present, in which the ground coffee can be deposited at the bottom of the brewing chamber and/or floating in the suspension.

The ground coffee may be present in a substantially uncompacted manner in the loosely filled state at the start of step b. This essentially means that a small amount of compaction of the ground coffee for the purpose of bringing it into form is possible. Typically, a loosely filled state has a conical shape. However, the bringing into form into a cylindrical shape can be carried out without mechanically compressing the volume of ground coffee to a greater extent. In contrast, a non-mechanical compression and/or compaction of a coffee ground fill, i.e., a compression or compaction without a mechanical force acting from the outside, is inherent to the brewing process due to the swelling of the ground coffee.

The ground coffee can be compacted somewhat after filling and in particular before the brewing process. In a preferred embodiment, however, the ground coffee is essentially uncompacted. This means that the ground coffee is compacted by less than 15% by volume, in particular less than 10% by volume, compared to a loosely filled state, i.e. as a loose pile.

This infinitesimal compression can take place in the course of shaping the ground coffee, for example to give the ground coffee a basic cylindrical shape in which extraction takes place more uniformly than in the case of a conical shape typical of loosely filling.

The water can then flow through the ground coffee during the at least one brewing phase without a mechanical pressing force being exerted on the ground coffee that further compresses it compared to the loosely filled state. Due to the swelling of the ground coffee, however, compaction can still occur without an external mechanical contact force being exerted on the ground coffee for this purpose. In particular, water supplied in step b can flow through the ground coffee essentially without the application of a pressing force.

The plunger can thus be moved or set to a second position in which it shapes the ground coffee, preferably before the brewing process. This makes it possible to achieve uniform distribution within the brewing chamber as a function of the amount of ground coffee.

Furthermore, and also optionally, the plunger can be maximally retracted in the first position, whereby the volume of the brewing chamber is maximally expanded. Individual brewing phases can be carried out in this maximally extended position. There may also be an air space between the suspension and the front surface of the plunger. However, the said first position does not necessarily have to represent the maximum extended state either, but can also be lower.

In addition to the main brewing phase, further brewing phases can also be provided. Preparatory or post-processing steps such as coffee grinding or subsequent cleaning, e.g. by CIP (clean in place), can also be part of the method according to the invention. In this case, parts do not have to be dismantled during CIP cleaning and cleaning can be carried out within the fully automatic machine by automatic processes.

The method makes it possible to implement filter coffee production in a fully automatic coffee machine in an uncomplicated manner. The free water volume enables, among other things, sponging of the ground coffee. In addition, the ground coffee can be flowed around more easily in an uncompacted state.

For a balanced extraction of the respective flavors, it is advantageous if the brewing process comprises several brewing phases in which water is passed through the ground coffee at different flow rates in relation to the brewing phases.

According to the invention, the change between the brewing phases is preferably performed by measuring instruments detecting and/or determining a physical variable, in particular the conductivity, the refractive index and/or the quantity of ground coffee and/or water supplied and/or the quantity or volume of coffee removed or discharged. This allows the maximum amount of flavor substances to be extracted. In this context, coffee is a natural product whose flavor substances can vary depending on the area of cultivation, roasting process, storage, etc. The preferred variant is a water-volume-controlled change as a function of the output quantity, taking into account the amount of ground coffee.

Advantageous embodiments of the invention are the subject matter of the subclaims.

As previously described, the plunger can remain in a first position during the brewing process, which is also described below as the rest position.

Preferably, the brewing chamber volume at the beginning of step b can be at least 50% larger, preferably twice as large, as the volume of the ground coffee in the loosely filled, in particular uncompacted, state.

Furthermore, preferably and advantageously, the brewing chamber is constructed in such a way that at the beginning of step b only the ground coffee is arranged inside the brewing chamber. In fact, the free volume of the brewing chamber, which is filled with hot water in step b, adjoins the ground coffee.

It is particularly advantageous in this context if the brewing process is
a) a first brewing phase with a second flow rate and
b) has a second brewing phase with a first flow rate and/or preferably a third brewing phase with a third flow rate,
   wherein the second flow rate may be less than the first flow rate and/or the third flow rate.

Advantageously, the brewing process is divided into at least 2, preferably 3, brewing phases, each of which can be assigned one of at least 2, preferably 3, different flow rates.

For example, the aforementioned second brewing phase can be designed as the main brewing phase. Furthermore, the first brewing phase can be designed as the pre-brewing phase and the third brewing phase as the post-brewing phase. However, this division or temporal sequence is not mandatory. Thus, the said second brewing phase can also be the first or the last brewing phase of the brewing process at the same time.

These process phases advantageously run one after the other, and particularly preferably immediately one after the other.

In this context, the second flow rate is preferably smaller than the third flow rate, which in turn is preferably smaller than the first flow rate.

The flow rate for at least one brewing phase of the brewing process may be comparatively slow and less than or equal to 10 ml/s, preferably 2-5 ml/s.

Preferably, the flow rate for at least the second brewing phase of the brewing process can be 2-5 ml/s. Also preferably, the flow rate for at least the first brewing phase of the brewing process may be 5-10 ml/s. In addition, the flow rate for at least the third brewing phase of the brewing process may be 10-15 ml/s.

The fully automatic coffee machine may further comprise a coffee grinder, wherein the method comprises grinding coffee beans to a predefined size for filter coffee. As is known, the grinding degree for filter coffee is coarser than the grinding degree for espresso coffee. Therefore, it is advantageous if the operating parameters of the coffee grinder are automatically set to an optimum grinding degree for filter coffee by the automatic coffee machine when the beverage request or selection “filter coffee” is made by the user.

The grinding degree can be determined according to DIN 44 539. DIN 44 539 defines three gradations for classifying the grinding degree. Grain sizes are defined which must account for a proportion of more than 50% of the ground material, in this case ground coffee. The value x_{50,3} indicates in the measurement report that 50% of the grind distribution is coarser and 50% is finer than the indicated measured value. The determination of the individual grain size fractions is carried out using the air jet sieve method according to DIN 10 765. The aforementioned regulations refer to the current version at the time of priority of the present invention.

### “Fine” Grinding Degree

All grain sizes up to a maximum of 0.25 mm result in a proportion of more than 50%.

### “Medium” Grinding Degree

The grain size between 0.25 mm and 0.71 mm result in a proportion of more than 50%.

### “Coarse” Grinding Degree

All grain sizes larger than 0.71 mm result in a proportion of more than 50%.

For the present method, a “medium” grinding degree or, particularly preferably, a “coarse” grinding degree is recommended.

It is recommended that the plunger brings the coffee powder into shape before the brewing process, so that the volume of the brewing chamber is reduced during the shaping process and for its purpose.

The plunger is retracted again after the first bringing into shape and thus does not rest on the ground coffee. This creates a large brewing chamber in which there is more space for the ground coffee to swell when it comes into contact with water. At the same time, non-compacted ground coffee has a lower flow resistance.

With this method of operation, one can assume an uncompacted flow behavior. When making conventional filter coffee in a coffee filter, on the other hand, the coffee powder often has to settle first, which takes additional time. Furthermore, it is advantageous if the plunger is retracted before the brewing process so that the volume of the brewing chamber expands again, preferably by at least 100% compared to the volume in the shaped state, so that slow extraction and low-pressure passage of the water is possible.

It is advantageous if the plunger remains in a rest position during the entire brewing process. The plunger can also be moved during pre-brewing and/or post-brewing.

At least during a brewing phase, a slow extraction is recommended.

In addition, the fully automatic coffee machine may have a filter, e.g., a sieve and, in particular, a CIP-capable permanent filter.

A change in the brewing phases can be made in particular by detecting a conductivity and/or a refractive index, with a measuring sensor for detection being arranged downstream of the brewing unit in terms of flow, so that the measurement result of the finished coffee, i.e. the end product, is taken as the basis for the change. Alternatively and preferably, the measuring sensor can also be arranged in front of the brewing unit in order to influence the properties while the coffee is still being prepared.

Particularly preferably, a change in the brewing phases can be set by detecting a supplied amount of water, taking into account the supplied amount of ground coffee. The supplied amount of ground coffee can be taken into account, for example, as part of an adjustment of the grinding capacity. The grinding capacity in mg/s at a preset grinding degree can be adjusted to the amount of water for a specific volume of filter coffee at the customer's request.

Furthermore, the brewing pressure during the brewing process is preferably less than 2.5 bar.

Preferably, the brewing chamber is closed except for an outlet for coffee during the brewing process. Optionally, an inlet for hot water can also be open.

Preferably, the flow rate is adjusted in steps during the brewing process to change between two brewing phases. Preferably, the change between all further brewing phases of the brewing process can also be adjusted in steps.

The fully automatic coffee machine can also have a bypass line starting from a hot water boiler to a dispensing unit with one or more control elements, wherein a dispensing of hot water takes place, preferably simultaneously with the brewing process and/or the dispensing of coffee from the brewing unit, to achieve a predetermined coffee volume. One or more valves can be used as control elements. Each valve defines a different flow rate.

According to the invention, there is also a fully automatic coffee machine comprising at least one brewing unit with a linearly displaceable plunger for setting a volume of a brewing chamber of the brewing unit and a control and/or evaluation unit which is set up to carry out a method according to the invention.

The fully automatic coffee maker can advantageously have a hot water boiler, wherein a flow rate limiter for setting a flow rate is arranged between the hot water boiler and the brewing unit. This enables the flow rate to be set after the respective first, second and/or third brewing phase and/or possibly further optional brewing phases.

The flow rate limiter can have a plurality of control elements, e.g. valves, which are designed for stepped adjustment of the flow rate to ensure a brewing process with several brewing phases with different flow rates. A stepped adjustment allows a very direct setting of a desired flow rate, whereas a stepless adjustment often allows a less optimal dosing due to an overrun that is difficult to detect.

In the following, the invention is explained in more detail by reference to an exemplary embodiment of a method according to the invention with the aid of the following figures, wherein:

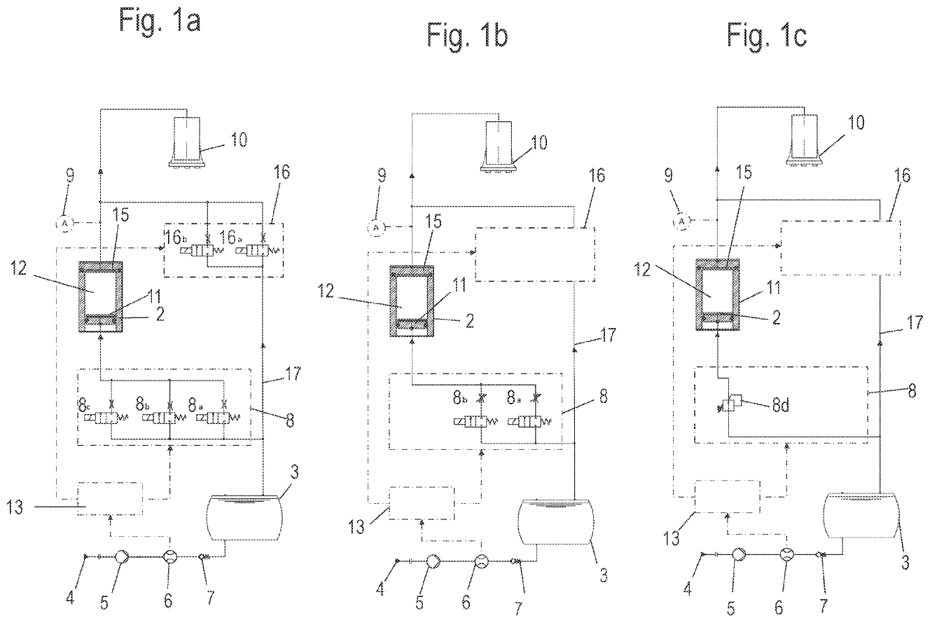

FIG. 1a shows a schematic structure of a first variant of a fully automatic coffee machine according to the invention;

FIG. 1b shows a schematic structure of a second variant of a fully automatic coffee machine according to the invention;

FIG. 1c shows a schematic structure of a third variant of a fully automatic coffee machine according to the invention;

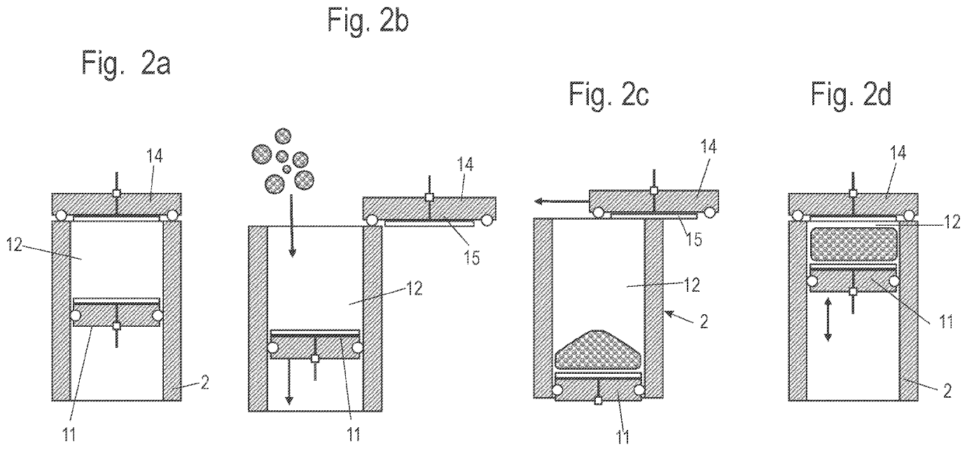

FIGS. 2a-g show detailed views of a brewing unit of the fully automatic coffee machine with a plunger in different operating positions during execution of the method according to the invention;

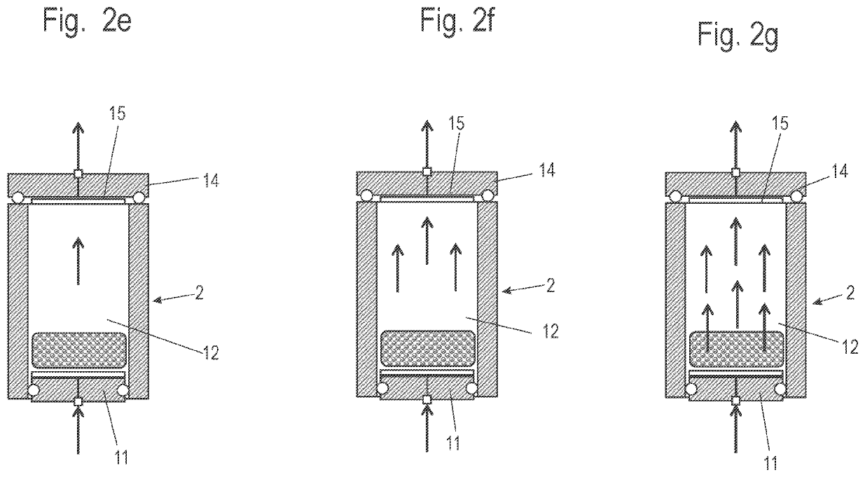

FIG. 3 shows a measurement of various physical quantities as a function of the course of the brewing process when carrying out the method according to the invention;

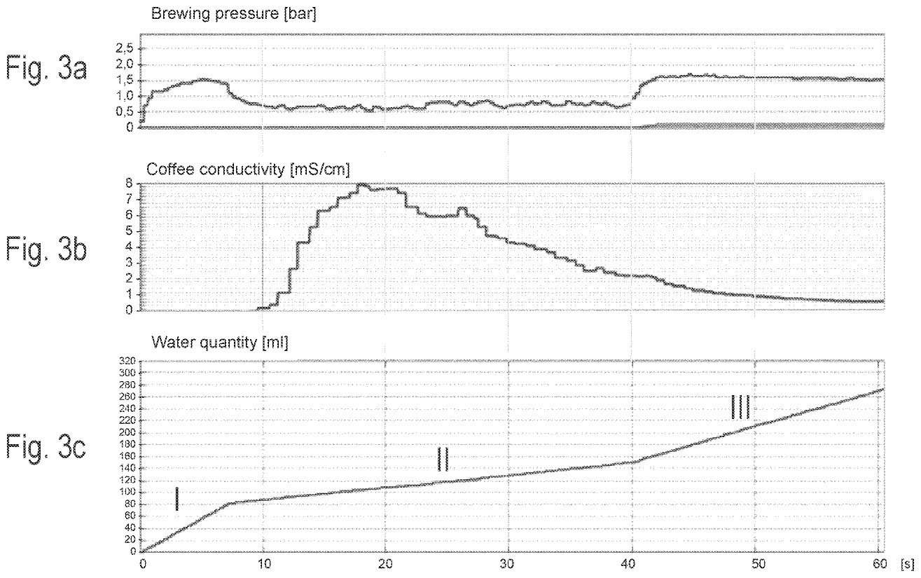

FIG. 4 shows a measurement diagram of an exemplary coffee extraction, e.g. on the basis of a conductivity, over a brewing process with several brewing phases according to a first embodiment variant of the method according to the invention; and

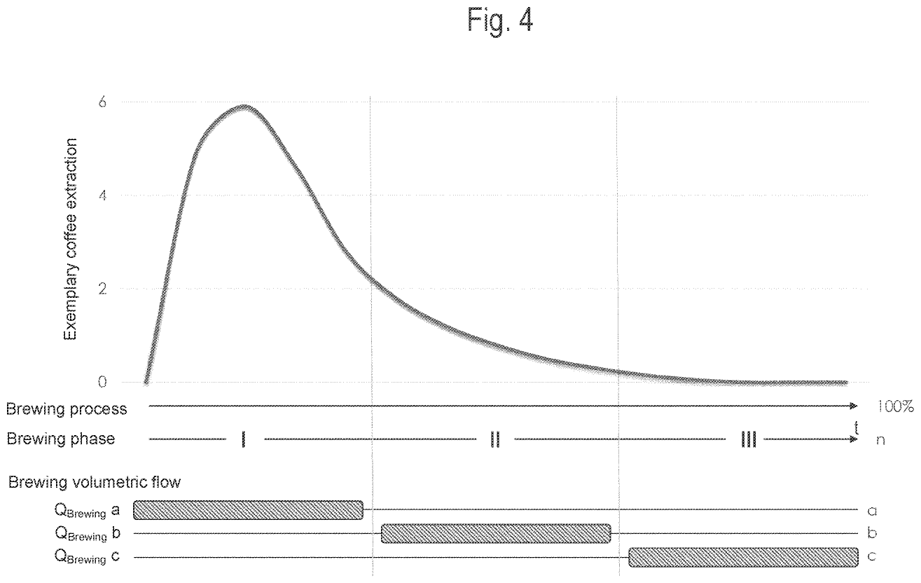

FIG. 5 shows a measurement diagram of an exemplary coffee extraction, e.g. on the basis of a conductivity, over a brewing process with several brewing phases according to a second embodiment variant of the method according to the invention.

FIG. 1 shows the basic structure of a fully automatic coffee machine 1 according to the invention.

The fully automatic coffee machine 1 has a brewing unit 2 and a hot water boiler 3 as central units. For the supply of water, the fully automatic coffee machine has a water inlet 4. This can be, for example, a removable water reservoir or a connection to a water pipe.

Furthermore, the automatic coffee machine 1 has a water pump 5 for conveying the supplied water into the hot water boiler 3.

In addition, the fully automatic coffee machine 1 has a measuring device for determining the flow rate 6. In the present exemplary embodiment, this is arranged upstream of the hot water boiler 3 in terms of flow and enables the water feed quantity into the boiler to be controlled at this position. Alternatively or additionally, an analog measuring device for flow rate determination can also be arranged between the hot water boiler 3 and the brewing unit 2 and/or downstream of the brewing unit 2 in terms of flow. The measuring device for determining the flow rate 6 can advantageously be designed as an impeller meter.

Furthermore, the supply line upstream of the hot water boiler 3 has a rebound valve 7.

The hot water boiler 3 then heats the supplied water to a temperature of preferably 80-96° C. Within this temperature range, the water temperature can be variably adjusted according to the desired hot beverage. Furthermore, the fully automatic coffee machine can have a non-displayed line for adding cold water in order to achieve a product-specific setting of the brewing temperature. The water heated in this way is then fed to the brewing unit 2, preferably in metered quantities.

If the water boiler 3 or alternatively also the brewing unit 2 has not already implemented a metering device, a flow rate limiter 8 can be provided between the water boiler 3 and the brewing unit 2 for more precise metering of the flow rates of hot water required in the respective method steps.

The flow rate limiter of FIG. 1a enables a stepped adjustment, in particular a stepped control, of the flow rate of the hot water supplied to the brewing unit 2. For this purpose, three brewing valves 8a-8c are provided in each case in FIG. 1a, wherein each of the brewing valves can have a different cross-section and consequently represents a different flow rate into the brewing unit. Preferably, one brewing valve is open in each case, while the other two brewing valves are closed.

In the variant of FIG. 1b, the flow rate limiter 8 is implemented by two brewing valves 8a and 8b. Here, too, at least three flow rates can be set in total, by opening each of the individual brewing valves 8a or 8b or by simultaneously opening both valves 8a and 8b. Preferably, in the variant of FIG. 1b, the cross-sections and thus flow rates downstream of the valve are continuously adjustable, e.g., manually adjusted needle valves. Thus a stepless flow rate adjustment of an otherwise step-set supply of a water quantity is possible.

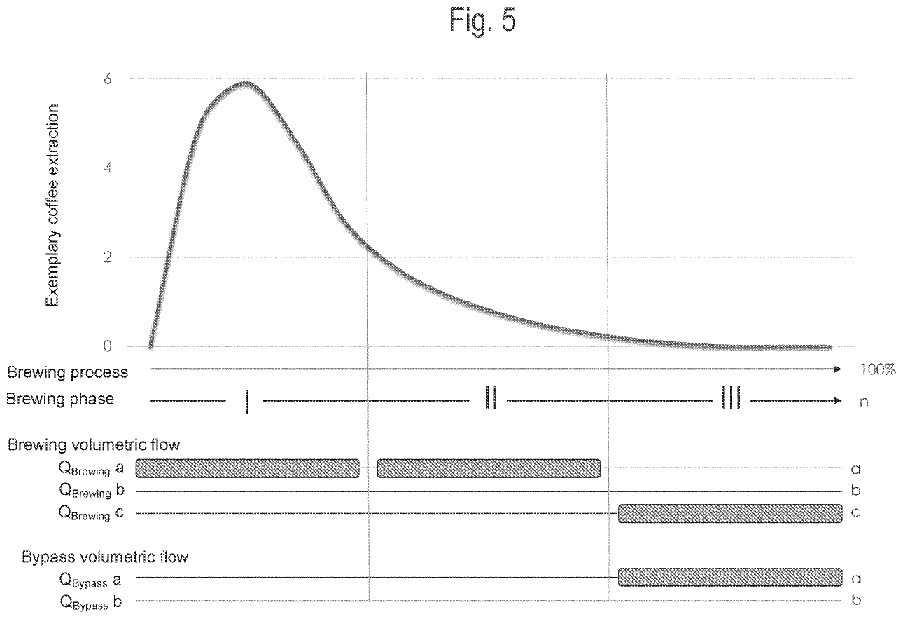

FIG. 1c discloses a variant in which a stepless valve 8d is used to adjust the flow rate. However, a stepwise change of the flow rates is preferred in order to enable a direct and fast regulation. Furthermore, for redundancy reasons, in the case of the stepped variant, in the event of failure of a valve, emergency operation can still be ensured for coffee withdrawal with reduced selection options. In addition, the stepped setting of FIGS. 8a and 8b enables fast feeding and discharging with clear or unambiguous switching states.

While a pressure limiter is often provided at this point in espresso machines, a flow rate limiter, e.g. a throttle, preferably a variably controllable throttle, is preferred here. Alternatively, the functions of a pressure limiter and a flow rate limiter can also be implemented together in one control element, so that the fully automatic coffee machine can be used in a more versatile way, i.e. for the production of more coffee variants.

The brewing unit 2 preferably has a brewing chamber 12 whose volume can be adjusted by a linearly movable plunger 11. The plunger position is variably adjustable. Furthermore, the brewing unit 2 has a filter 15, preferably a permanent filter. The permanent filter is preferably CIP-capable. The permanent filter may in particular be a microfine sieve. Particularly preferably, the sieve may have at least 30,000 holes, preferably at least 40,000 holes, per 1.*10³ mm.

The brewing unit can be filled with ground coffee by manual filling, i.e. by direct insertion of the ground coffee, e.g. via a feed chute, or by grinding whole beans immediately before feeding them into the brewing unit. For this purpose, the fully automatic coffee machine may have a non-displayed coffee grinder. Since ground coffee for filter coffee usually has a coarser grinding degree than espresso powder, it is advantageous if the integrated coffee grinder is equipped to produce a variable grinding degree. This is matched to the type of coffee and the type of filter, in particular the permanent filter. Corresponding parameters are, for example, the degree of fineness or the distribution. Further details of a coffee grinder with a variable grinding degree can be found in DIN 44539 (in the current version at the time of the present application), which is referenced in the context of the present application. The grinding degree can be variably adjusted, for example, by varying the grinding time, speed, pressure of the grinding elements and/or roughness of the grinding elements.

In addition or as an alternative to the flow rate limiter 8, the fully automatic coffee machine 1 can have a measuring sensor 9, in particular a physical measuring sensor for determining a coffee property. This is preferably arranged downstream of the brewing unit 2 in terms of flow. This coffee property can preferably be the conductivity, the refractive index, the pressure and/or the temperature. A variant of the measurement in this context is described in detail, inter alia, in DE 10 2018 116 306 A1, to which reference is hereby made. Alternatively and particularly preferably, the measuring sensor can also determine a volumetric flow of coffee leaving the brewing unit.

Finally, the coffee is forwarded to a dispensing unit 10. In addition, the fully automatic coffee machine 1 may have further blocking and/or diverting valves at various positions.

In particular, the fully automatic coffee machine has a bypass line 17 between the hot water boiler 3 and the dispensing unit 10 for supplying hot water to the dispensing unit without this having previously been passed through the brewing unit 2. In particular, the bypass line 17 enables a reduction of the coffee preparation time due to a parallel supply of hot water to the coffee. In particular, it may be that hardly any flavoring substances are extracted in a post-brewing phase, so that the preparation time is shortened to the desired volume by the supply of hot water. In this case, no bitter substances are supplied via the bypass line 17, as can be the case with longer extraction times in the brewing unit. Nevertheless, the desired volume can be maintained.

The hot water can be supplied to the dispensing unit by several predefined supply rates, wherein control elements 16, e.g. bypass valves 16a and 16b, are provided for setting a flow rate. Preferably, the flow rate and the supply volume can be made in dependence on the values determined by the measuring sensor 9 or in dependence on the flow rates.

The operation of the brewing unit 2 and/or the hot water boiler 3 is controlled by a control and/or evaluation unit 13. The control and/or evaluation unit preferably has a computing unit and a data memory on which one or more data records or databases are stored, which are called up when the method according to the invention is carried out.

The method according to the invention for producing a coffee beverage with the characteristics of a filter coffee is carried out according to several steps. In this process, the brewing unit 2 designed as a plunger unit and other core components of the fully automatic coffee machine are used for fully automatic filter coffee production.

A previously defined quantity of ground coffee is fed into the brewing chamber 12 and hot water is passed through it, at a low volume flow, with the plunger retracted. The coffee extracted under these conditions has the characteristic features of freshly brewed filter coffee. Investigations have shown that the coffee beverage produced has a directly comparable result to filter coffee production, e.g. in a glass filter. In the following, the method according to the invention is described in detail on the basis of an embodiment variant.

In a first step, a user enters a beverage request. The beverage request can be transmitted electronically, e.g. via a cell phone app, or by triggering a control element, e.g. a control panel or a button on the fully automatic coffee machine.

Then, in a second optional step, coffee beans are ground to an optimum size for filter coffee by the coffee grinder. In machines with a plurality of storage tanks, e.g. for espresso beans or coffee beans, there is also the option of selecting the type of bean to be fed to the coffee grinder.

Alternatively, ground coffee can be fed to the brewing unit by direct insertion—before or after the first step.

In a third step FIGS. 2a-2c, the brewing chamber 12 of the fully automatic coffee machine 1 is filled, e.g. by opening a slide 14, cf. FIGS. 2a and 2b, the brewing chamber 12 is opened and ground coffee, cf. FIGS. 2b and 2c, is fed in. In FIG. 2c, the ground coffee is then in the form of a cone.

In a fourth step, shown in FIG. 2c, the brewing chamber is then closed, e.g. by operating the slide 14, and the brewing chamber 12 is sealed. The plunger 11 of the brewing unit 2 can be operated briefly, depending on the amount of ground coffee, to bring the ground coffee into shape. This is shown in FIG. 2d. Here, the ground coffee is only slightly compressed, but merely shaped cylindrically in order to achieve a more uniform extraction. The plunger is then returned to its original position to increase the volume of the brewing chamber.

Next, the brewing chamber 12 is widened to introduce water so that there is room for the ground coffee to swell upon contact with water. This can be seen in FIGS. 2d and 2e.

In a fifth step, hot water is supplied at a first flow rate. This is referred to below as the first brewing phase, e.g. in a pre-brewing phase. This involves partial and rapid filling of the brewing chamber. To ensure a phase transition of the aroma substances, a certain holding time can optionally be provided. Preferably, the flow rate during pre-brewing is between 9-12 ml/s. After the rapid feed in the pre-brewing phase, a holding time can be provided in which the flow rate is reduced but the brew valve(s) remain open. This can preferably be at least 3 seconds.

Then, in a sixth step, hot water is supplied again in a second brewing phase at a second flow rate. This can be the main brewing phase, for example. Hot water is supplied slowly, preferably at a flow rate of less than 5 ml/s, particularly preferably less than 3 ml/s. Uniform extraction is achieved by the slow flow rate, in which soluble substances are also entrained.

At the end of the sixth step, the mass transfer of a large part of the aroma substances into the water is complete. The duration of the brewing phase can be controlled as a function of time, quantity (volume or mass of water supplied), pressure and/or, particularly preferably, conductivity.

Finally, in a seventh step, the flow rate is increased again, e.g. to 5-10 ml/s. The terms flow rate or volumetric flow rate are to be understood synonymously in the context of the present application. This third flow rate corresponds to the third brewing phase, which may be the so-called post-brewing phase. This phase is preferred to obtain a balanced extraction result.

Finally, in an eighth step, the ground coffee is ejected from the brewing chamber.

During the individual brewing phases, the brewing chamber can remain open on the drain side, so that the coffee is dispensed into a coffee cup after each phase, i.e. during preparation.

The coffee in the brewing chamber can be fed to the output as required, by closing the plunger.

The pressure of 4 bar, or in particular 2.5 bar, is preferably not exceeded during all brewing phases of coffee production. On the contrary, the coffee preparation can be carried out particularly preferably without additional pressure from the plunger 11 during the brewing phases.

The phase transition between the different brewing phases can occur as a function of the following physical variables and can vary depending on both the amount of ground coffee and the total amount of water:
a) Time-controlled by means of a data set value or by a preset after time x [s] has elapsed.
   This variant varies in particular with the amount of coffee, the volume of water and/or the desired coffee volume.
b) Quantity-controlled by means of a data set value or by a presetting according to/at quantity x [ml].
c) Conductivity-controlled by means of a data set value or by a presetting after falling below a proportion of measured conductivities of substances during the brewing process [mS/cm].
   In this variant, it is possible to determine in particular when the proportion of conductive substances has been extracted for the most part.

The volumetric flow of warm or hot water during the respective brewing phases can be regulated or controlled and can vary depending on both the amount of ground coffee and the total amount of water.

The preparation is preferably carried out “cup by cup”, storage e.g. in an internal hot holder of the fully automatic coffee machine before dispensing is conceivable.

The entrainment of large particles (coll. or similar crumbs) from the ground coffee into the beverage is preferably prevented by the use of the filter.

The brewing chamber volume can be variably changed automatically, preferably before brewing, and adjusted to the desired output volume of the coffee.

Preferably, the brewing pressure can be determined upstream and/or downstream of the brewing chamber 12 for measurement data collection.

A specific preparation sequence is given below as one embodiment.

### Brewing Phases

| | | | | | |
|---|---|---|---|---|---|
| I. | 0-8 | s | [80 | ml] | Pre-brewing |
| II. | 8-40 | s | [70 | ml] | Brewing |
| III. | 40-70 | s | [150 | ml] | Post-brewing |

### Parameter

Amount: 300 ml
Duration: 70 s
Amount weighed: 10 g
Conductivity: 2.45 mS/cm (Ø)
Brewing pressure: 0.5 bar
Brewing temperature: 92° C.

The measurement diagrams in FIG. 3 were created under these conditions. In the pre-brewing phase I, a pressure increase can be seen due to the rapid supply of water, wherein a low pressure can be built up by plunger 11.

During the main brewing phase II, it can be seen from the increase in conductivity (FIG. 3b) that a large proportion of ingredients are transferred during this phase. The flow rate (FIG. 3c) is significantly lower than in the pre-brewing phase I. As can be seen from the pressure curve, the main brewing phase takes place without any significant pressure build-up (FIG. 3a).

This pressure increases again in post-brewing phase III. The flow speed is also increased. The conductivity is low compared to the main brewing phase and continues to decrease in the course.

FIG. 4 shows a first variant in which a brewing process runs in three different brewing phases I, II, III. The volumetric flows Q_{Brewing} a, b and c and thus also the first, second and third flow rates vary depending on the brewing phase. Based on the conductivity, the extraction of flavors can be traced. It can be seen that only a few flavors are extracted, particularly in the third brewing phase III.

Preferred flow rates or volumetric flows for the individual brewing phases of FIG. 4 but also for other process variants are as follows:
First flow rate: Q_{Brewing} a: 2-5 ml/s
Second flow rate: Q_{Brewing} b: 5-10 ml/s
Third flow rate: Q_{Brewing} C: 10-15 ml/s

FIG. 5 shows an alternative second variant of a method according to the invention in which two brewing phases I and II with identical volumetric flows Q_{Brewing} a are passed through the brewing chamber and in which a third brewing phase III with a different volume flow Q_{Brewing} c is operated simultaneously with a volumetric flow of hot water via a bypass line Q_{Bypass} a. The third brewing phase III is used to extract residual coffee and possibly also some bitter substances. In this third brewing phase III, in addition to residual extraction, optionally also of some bitter substances, the main aim is to achieve a desired volume of coffee.

As can be seen from FIG. 5, the method according to the invention does not necessarily have to include three brewing phases with three different volume flows or flow rates, but it is possible to do so and thereby achieve a more balanced taste.

The bypass volume flow Q_{Bypass} b can be switched on, for example, in the second brewing phase II or at the end of the brewing process after completion of the third brewing phase III.

### LIST OF REFERENCE SIGNS

1 Fully automatic coffee machine
2 Brewing unit
3 Hot water boiler
4 Water inlet
5 Water pump
6 Measuring device for flow rate determination
7 Rebound valve
8 Flow rate limiter
8a-8c Brewing valves
9 Measuring sensor
10 Output unit
11 Plungers
12 Brewing chamber
13 Control and/or evaluation unit
14 Slide
15 Filter
16 Control elements
16a-16b Bypass valves
17 Bypass
FIG. 3a Pressure measurement over the course of the brewing process
FIG. 3b Conductivity diagram over the course of the brewing process
FIG. 3c Flow rate measurement over the course of the brewing process
I First brewing phase
II Second brewing phase
III Third brewing phase

1: A method for making a coffee beverage with a filter-coffee taste by means of a fully automatic coffee machine (1), wherein the fully automatic coffee machine (1) has at least one brewing unit (2) with a brewing chamber and has a plunger (11) which is movable in the brewing chamber for setting a brewing chamber volume, wherein the method comprises the following steps:
a. filling the brewing chamber (12) with ground coffee; and
b. feeding water into the brewing chamber (12) for the purpose of extraction in the course of a brewing process,
wherein at least the plunger (11) is arranged during at least one brewing phase of the brewing process in a position in which a brewing chamber volume is greater than a volume of the ground coffee in a loosely filled state in the brewing chamber (12) after the filling according to step a has taken place, wherein the brewing process comprises a number of brewing phases (I, II, III) in which water is made to pass through the ground coffee with different flow rates relative to the brewing phases (I, II, III) and wherein a change between the brewing phases (I, II, III) is performed by measuring instruments detecting and/or determining a physical variable in the form of conductivity, refractive index and/or amount and/or volume of ground coffee and/or water supplied and/or amount of coffee removed.

2: The method according to claim 1, wherein the change of the brewing phases (I, II, III) is adjusted by detecting the supplied amount of water by taking into account a supplied amount of ground coffee.

3: The method according to claim 1, wherein the change of the brewing phases (I, II, III) is performed by detecting measured values by a measuring sensor (9), wherein the measuring sensor (9) is arranged downstream or upstream of the brewing unit (2) in terms of flow.

4: The method according to claim 1, wherein the water flows through the ground coffee during the at least one brewing phase without exerting a mechanical contact pressure on the ground coffee that is further compressive compared to the loosely filled state.

5: The method according to claim 1, wherein the ground coffee is substantially present in an uncompacted manner in the loosely filled state at the start of step b.

6: The method according to claim 1, wherein the brewing chamber volume at the beginning of step b is at least 50% larger than the volume of the ground coffee in the loosely filled state.

7: The method according to the claim 1, wherein the brewing chamber is constructed in such a way that at the beginning of step b only the ground coffee is arranged inside the brewing chamber.

8: The method according to claim 1, wherein the brewing process comprises a first brewing phase (I) with a second flow rate and a second brewing phase (II) with a first flow rate and a third brewing phase (III) with a third flow rate, wherein the second flow rate is smaller than the first and/or the third flow rate.

9: The method according to claim 8, wherein the flow rate (Q_{Brewing} a or Q_{Brewing} b) for at least one brewing phase of the brewing process is less than or equal to 10 ml/s.

10: The method according to claim 8, wherein the flow rate (Q_{Brewing} b) for at least the first brewing phase (I) of the brewing process is 5-10 ml/s.

11: The method according to claim 8, wherein the flow rate (Q_{Brewing} a) for at least the second brewing phase (II) of the brewing process is 2-5 ml/s.

12: The method according to claim 8, wherein the flow rate (Q_{Brewing} c) for at least the third brewing phase (III) of the brewing process is 10-15 ml/s.

13: The method according to one of the claim 1, wherein the fully automatic coffee machine (1) comprises a coffee grinder, wherein the method comprises grinding coffee beans to a predefined size for filter coffee.

14: The method according to claim 1, wherein the plunger (11) performs, prior to step b, a shaping process of a bulk of the ground coffee without substantial compression of the bulk of the ground coffee, so that the volume of the brewing chamber (12) is reduced during the shaping process.

15: The method according to claim 14, wherein prior to the brewing process, the plunger (11) is returned to a first position so that the volume of the brewing chamber (12) expands again.

16: The method according to claim 15, wherein the plunger (11) remains in the first position during the entire brewing process.

17: The method according to claim 15, wherein the plunger (11) can be adjusted to a second position in which the plunger rests on the ground coffee along an end face without exerting a contact pressure on the ground coffee during the shaping process.

18: The method according to claim 15, wherein the plunger (11), in the first position, is present in a maximally extended position, limited by a structural design of the brewing unit (2).

19: The method according to claim 1, wherein the fully automatic coffee machine (1) has a filter (15) as part of the brewing unit (2).

20: The method according to claim 1, wherein a brewing pressure during the brewing process is less than 4 bar.

21: The method according to claim 1, wherein the brewing chamber (12) is closed during the brewing process except for an inlet for hot water and/or an outlet for coffee.

22: The method according to claim 1, wherein the fully automatic coffee machine has a bypass line starting from a hot water boiler to a dispensing unit (19) with one or more control elements, wherein a dispensing of hot water takes place to achieve a predetermined coffee volume.

23: The method according to claim 1, wherein a stepwise adjustment of a flow rate is performed during the brewing process to alternate between two brewing phases.

24: A fully automatic coffee machine (1) comprising at least one brewing unit (2) with a linearly displaceable plunger (11) configured for setting a volume of a brewing chamber (12) of the brewing unit (2) and a control and/or evaluation unit (13) which is set up to carry out a method according to claim 1.

25: The fully automatic coffee machine according to claim 24, wherein the automatic coffee machine (1) comprises a hot water boiler (3), wherein a flow rate limiter (8) for setting a flow rate is arranged between the hot water boiler (3) and the brewing unit (2).

26: The fully automatic coffee machine according to claim 25, wherein the flow rate limiter (8) is designed for stepwise adjustment of the flow rate to ensure a brewing process with several brewing phases with different flow rates.
